(19) United States
(12) Patent Application Publication
(10) Pub. No.: US 2019/0075621 A1
(43) Pub. Date: Mar. 7, 2019

(54) COOKING CONTAINER FOR ELECTROMAGNETIC INDUCTION HEATING

(71) Applicants: Kim Jung WOOK, Daegu (KR); Kim Tae SUCK, Daegu (KR)

(72) Inventors: Kim Jung WOOK, Daegu (KR); Kim Tae SUCK, Daegu (KR)

(21) Appl. No.: 16/121,992

(22) Filed: Sep. 5, 2018

(30) Foreign Application Priority Data
Sep. 6, 2017 (KR) 10-2017-0113857

(51) Int. Cl. H05B 6/12; A47J 36/02; A47J 27/00

(52) U.S. Cl. CPC H05B 6/1209; A47J 27/002; A47J 36/022

(57) ABSTRACT

The present invention relates to a cooking container for an electromagnetic induction heating, in which the cooking container includes: a cooking container main body formed of an aluminum alloy; and a magnetic metal plate attached to an outer bottom surface of the cooking container main body, wherein the magnetic metal plate is formed at a surface thereof with a plurality of grooves having a bowl shape formed by pressing the surface of the magnetic metal plate, in which the bowl-shape groove is formed at a bottom thereof with a boss through-hole, and the cooking container main body has a plurality of bosses passing through boss through-holes of the grooves of the magnetic metal plate, in which the bosses are pressed to fill the bowl-shape grooves, respectively, such that a side surface of the bowl-shape groove of the magnetic metal plate is buried in the cooking container main body.

### BACKGROUND OF THE INVENTION

### 1. Field of the Invention

The present invention relates to a cooking container for electromagnetic induction heating and a method of manufacturing the same.

### 2. Description of the Related Art

Recently, the use of a cooker for electromagnetic induction heating is gradually increasing. The cooker for the electromagnetic induction heating is used with less oxygen consumption and no discharge of a waste gas as compared with a gas stove, so that contamination of indoor air and increase in an indoor temperature can be reduced. The cooker for the electromagnetic induction heating is heated by inducing heat to a heating target container, so that high energy efficiency and safety are achieved. In addition, the heat is generated in the heating target container by the induction heating, and a contact surface is not heated, so that a risk of burning is low. Therefore, the use of the cooker for the electromagnetic induction heating is gradually increasing as residential environments such as high-rise apartments where a gas pipe is difficult to be installed are improved.

In the cooker for the electromagnetic induction heating, an alternating magnetic field in a range of 50 kHz to 1 MHz is generated from an outside and transmitted to a container responsive to the alternating magnetic field to generate heat. When an alternating current flows in a coil, the alternating magnetic field is generated in a direction perpendicular to a direction of the current, and the alternating magnetic field is transmitted to a magnetic substance of a cooking container containing a heating target food to generate a hysteresis loss, thereby generating the heat. Therefore, the cooking container used for the cooker for the electromagnetic induction heating or a part thereof has to be formed of a magnetic substance.

The cooking container formed of an aluminum alloy which is relatively lightweight and has a high thermal conductivity is generally used. However, the cooking container formed of the aluminum alloy cannot be used in the cooker for the electromagnetic induction heating because aluminum is a non-magnetic substance. Therefore, a cooking container main body is formed of the aluminum alloy, and a magnetic metal plate such as a ferritic stainless plate is bonded to an outside of a bottom surface of the cooking container, so that the cooking container is used for the cooker for the electromagnetic induction heating as well as for heating by gas fire.

A cooking container, in which a magnetic metal plate using a non-magnetic metal such as aluminum as a main material to perform a heating action on foods by the electromagnetic induction heating, preferably a magnetic metal plate formed of a material such as stainless steel is attached to an outside of a bottom plate of the cooking container formed of a material such as aluminum, is used. However, as heating and cooling are repeatedly performed during the use, thermal expansion and shrinkage ratio are different among different kinds of metals having different physical properties, particularly thermal expansion coefficients, so that lifting, deformation, or separation may occur between the cooking container main body and the magnetic metal plate. Therefore, it is difficult to form a desired bottom plate part for foods by bonding the cooking container main body to the magnetic metal plate in a reliable and stable state while maintaining a beautiful appearance in schemes such as simple welding or pressure welding.

One conventional method used to solve the above problem includes forming flower-shape protrusions on one surface of a magnetic metal plate formed of stainless steel, and pressure-welding the magnetic metal plate and a non-magnetic metal plate with each other while the protrusions of the magnetic metal plate face the non-magnetic metal plate, so that the protrusions on the magnetic metal plate are deformed while penetrating into the non-magnetic metal plate so as to allow the metal plates to be coupled to each other.

### DOCUMENTS OF RELATED ART

### Patent Documents

Japanese Patent Application Publication No. 2003-102616

### SUMMARY OF THE INVENTION

Japanese Patent Application Publication No. 2003-102616 discloses a cooking container used in an induction heating cooker and a method of attaching a magnetic metal plate to a bottom surface of a cooking container.

In a method of manufacturing a cooking container disclosed in Japanese Patent Application Publication No. 2003-102616, a cooking container main body is prepared by a casting scheme. In this case, a boss part is formed on a rear bottom surface of the cooking container according to a predetermined pattern, a magnetic metal plate formed with a through-hole according to the pattern of the boss part is provided such that the boss part formed on the rear bottom surface of the cooking container is fitted into the through-hole of the magnetic metal plate to protrude upward, and the boss part is pressed and held with a press to allow the magnetic metal plate to be caulked by a peripheral boundary of each of the through-hole and other peripheral boundaries. The method includes a bonding process of bonding the magnetic metal plate to the rear bottom surface of the cooking container main body, and a rear bottom surface shaping process of shaping the rear bottom surface of the cooking container main body into a substantially smooth surface by cutting and polishing upper surfaces of all bosses and the caulked annular protrusions.

However, since the cutting and polishing has to be performed, the processes are complicated, and since the upper surfaces of all the bosses and the caulked annular protrusions are cut and polished, a gap may be formed between the magnetic metal plate and the cooking container main body as time passes, and water may permeate into the gap, causing the magnetic metal plate to be separated from the cooking container main body.

To solve the problems described above, according to the present invention, there is provided a cooking container for an electromagnetic induction heating, in which the cooking container includes: a cooking container main body formed of an aluminum alloy; and a magnetic metal plate attached to an outer bottom surface of the cooking container main body, wherein the magnetic metal plate is formed at a surface thereof with a plurality of grooves having a bowl shape formed by pressing the surface of the magnetic metal plate, in which the bowl-shape groove is formed at a bottom thereof with a boss through-hole, and the cooking container main body has a plurality of bosses passing through boss through-holes of the grooves of the magnetic metal plate, in which the bosses are pressed to fill the bowl-shape grooves, respectively, such that a side surface of the bowl-shape groove of the magnetic metal plate is buried in the cooking container main body.

In this case, an aluminum alloy portion of a bottom surface of the cooking container may be exposed out of the magnetic metal plate.

In addition, the magnetic metal plate and the aluminum alloy portion exposed out of the magnetic metal plate may be coplanar with each other.

In addition, a flange may be formed around the boss through-hole.

According to the present invention, a method of manufacturing a cooking container for electromagnetic induction heating by attaching a magnetic metal plate to an outer bottom surface of a cooking container main body formed of an aluminum alloy includes: preparing the cooking container main body by a liquid metal forging scheme to form a plurality of bosses on a bottom surface of the cooking container main body; forming a groove having a bowl shape by pressing a surface of the magnetic metal plate, in which the bowl-shape groove is formed at a bottom thereof with a boss through-hole; allowing the bosses formed on the cooking container main body to respectively pass through boss through-holes of a plurality of bowl-shape grooves of the magnetic metal plate to allow the bosses to be exposed on the surface of the magnetic metal plate by overturning the cooking container main body and putting the magnetic metal plate on the cooking container main body; and pressing each of the bosses exposed on the surface of the magnetic metal plate to fill each of the bowl-shape grooves such that a side surface of the bowl-shape groove is buried in the cooking container main body.

In the above manufacturing method, one of AC4C, which is an Al—Si—Mg-based alloy, and AC8C, which is an Al—Si—Cu—Mg—Ni-based alloy, according to Japanese Industrial Standard (JIS) may be used as the aluminum alloy.

According to the present invention, the side surface of the bowl-shape groove of the magnetic metal plate is buried in the cooking container main body, so that the magnetic metal plate can be prevented from being separated from the container main body. In addition, since the side surface of the bowl-shape groove of the magnetic metal plate is buried in the cooking container main body, it is possible to remarkably reduce foreign substances being caught in a gap formed between the container main body and the magnetic metal plate.

In addition, the side surface of the bowl-shape groove of the magnetic metal plate is buried in the cooking container main body, so that heat transfer efficiency is remarkably increased between the container main body and the magnetic metal plate.

### BRIEF DESCRIPTION OF THE DRAWINGS

FIG. 1 is a perspective view showing a bottom surface of a cooking container for electromagnetic induction heating according to the present invention.

FIG. 2 is a cut-away perspective view in which FIG. 1 is cut along a cutting line II-II.

FIG. 3 is an enlarged view showing a portion III surrounded by a circle in FIG. 2.

FIG. 4 is a cut-away perspective view showing a magnetic metal plate.

FIG. 5 is an enlarged view of a portion V surrounded by a circle in FIG. 4.

FIG. 6 is a view obtained by overturning FIG. 5.

FIG. 7 is a cut-away perspective view showing a bottom surface of a cooking container-shape main body formed with bosses.

FIGS. 8 to 10 are sectional views showing a process of coupling the magnetic metal plate to the bottom surface of the cooking container main body, in which FIG. 8 is a cut-away sectional view showing a state in which the cooking container-shape main body formed with the bosses is cut, FIG. 9 is a cut-away sectional view showing a state in which the magnetic metal plate is coupled, and FIG. 10 is a cut-away sectional view showing a state in which the bosses are pressed to be coplanar with a surface of the magnetic metal plate.

FIG. 11 is an enlarged perspective view showing a portion XI surrounded by a circle in FIG. 8.

FIG. 12 is an enlarged perspective view showing a portion XII surrounded by a circle in FIG. 9.

FIG. 13 is an enlarged perspective view showing a portion XIII surrounded by a circle in FIG. 10.

FIG. 14 shows a mold device for liquid metal forging, which is used for molding a main body of the cooking container for the electromagnetic induction heating.

FIG. 15 is an exploded perspective view showing the mold device for the liquid metal forging.

FIG. 16 is an enlarged perspective view showing a portion XVI surrounded by a circle in FIG. 15.

FIG. 17 is a sectional view showing the mold device for the liquid metal forging.

FIGS. 18 to 20 are views showing processes of molding the cooking container main body.

FIG. 21 is a view showing the cooking container main body before a finishing process.

FIG. 22 is a view showing the cooking container main body after the finishing process.

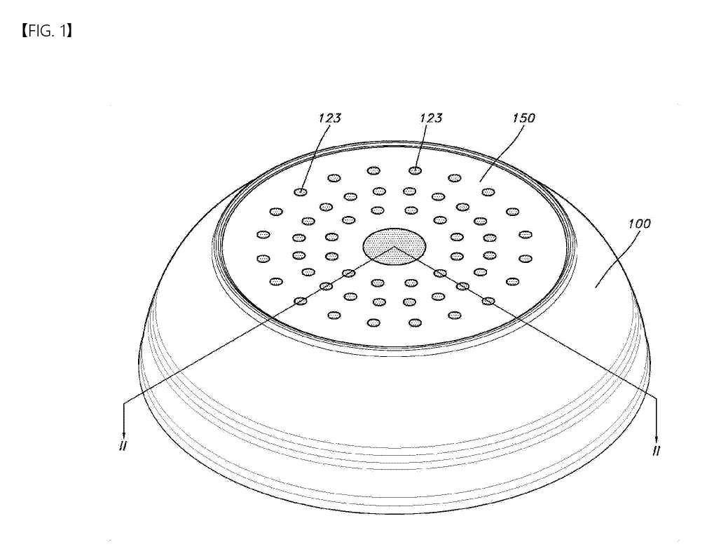

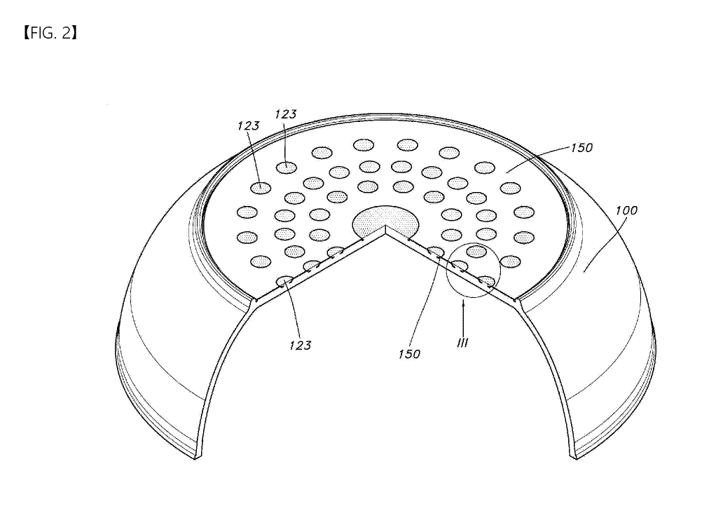

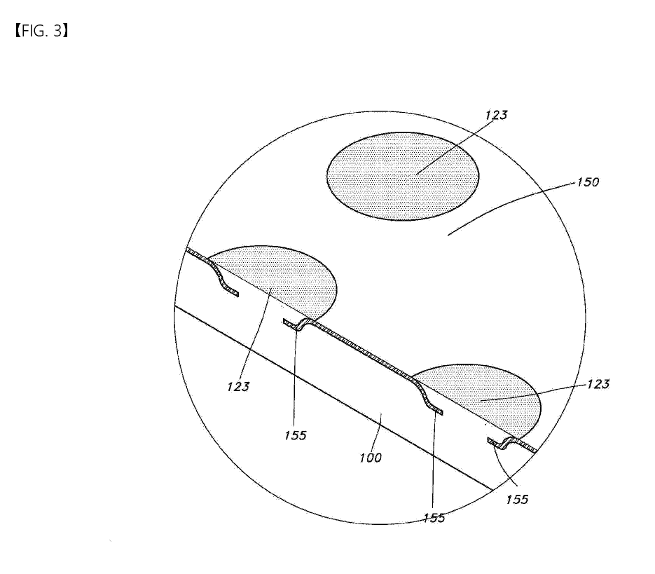

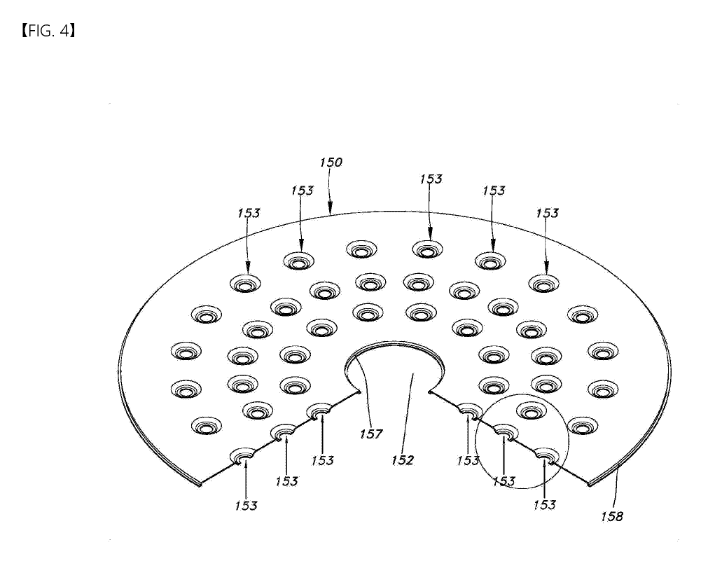

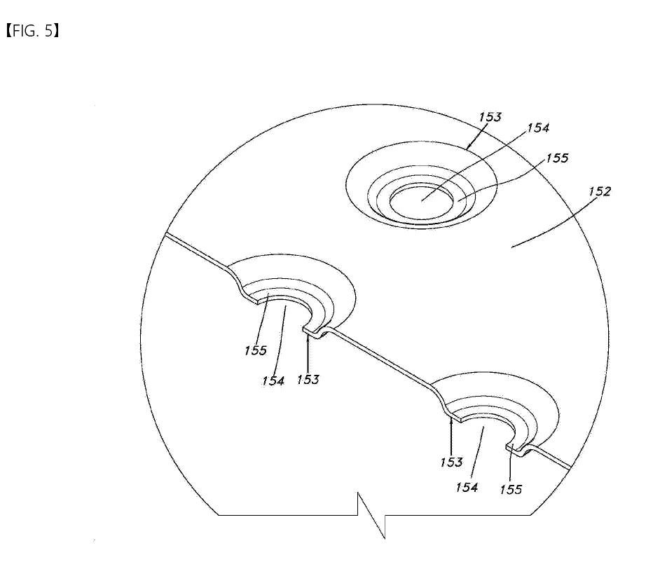

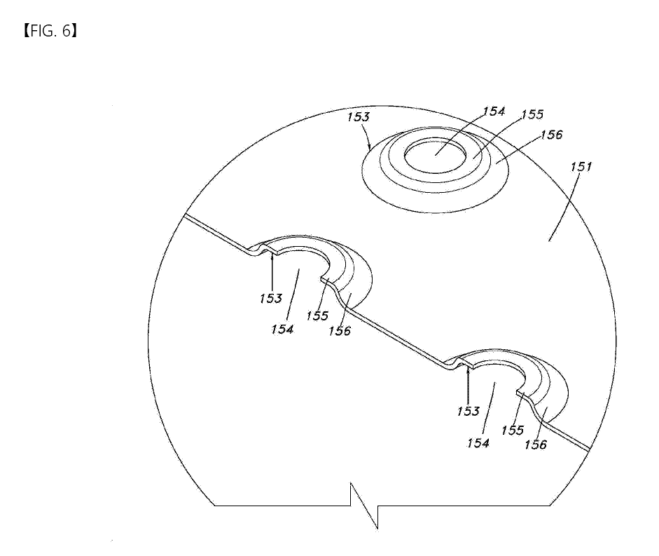

### DETAILED DESCRIPTION OF THE INVENTION

A plunger 231 for shaping an inside of a main body of a cooking container is fitted in a recess 221c of a body mold 221. The main body of the cooking container is molded by a cavity (space) between the body mold 221 and the plunger 231. A ring member 203 is disposed at a periphery of the body mold 221 and the plunger 231. The ring member 203 guides the plunger 231 to the recess 221c of the body mold 221 while forming an inlet part of the container. The plunger 231 is attached to a press member 126.

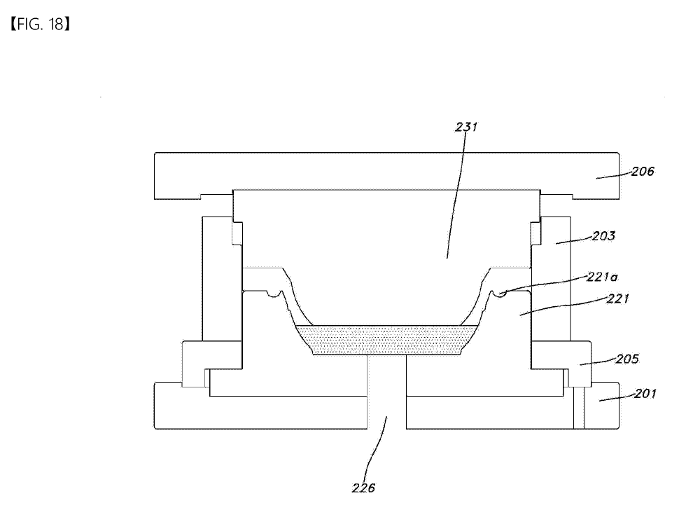

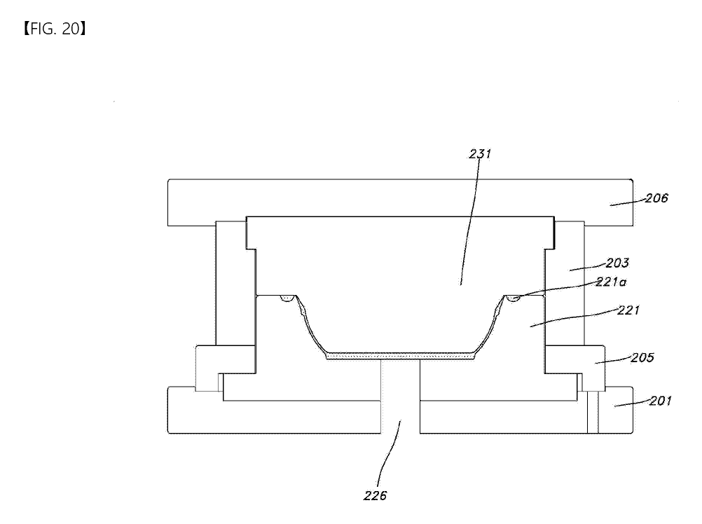

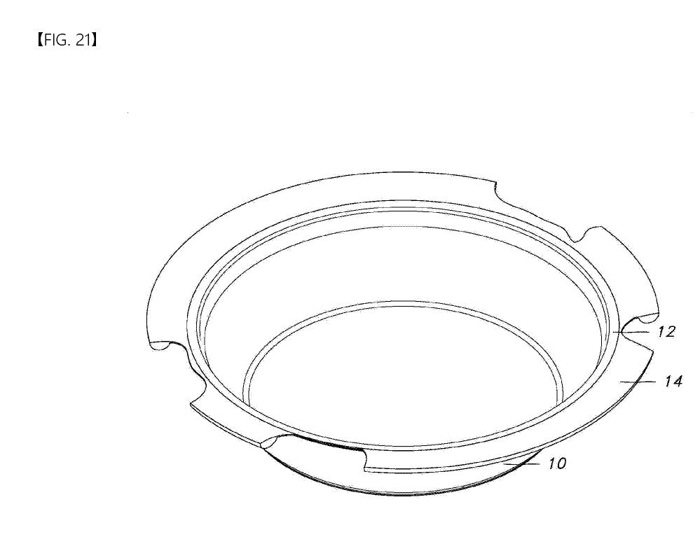

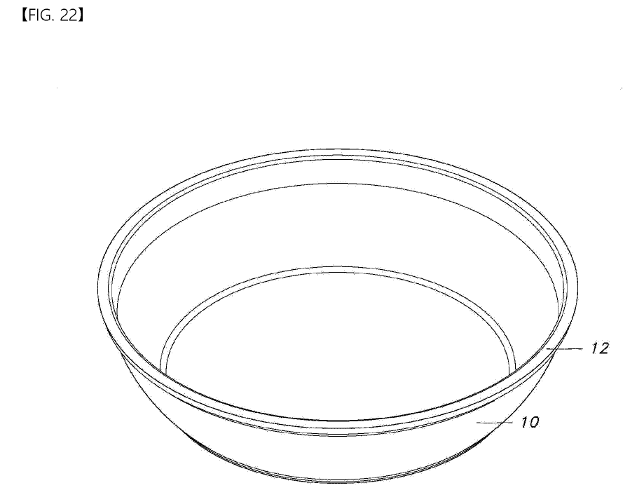

FIGS. 18 to 20 are views showing processes of molding the cooking container main body, FIG. 21 is a view showing the cooking container main body before a finishing process, and FIG. 22 is a view showing the cooking container main body after the finishing process.

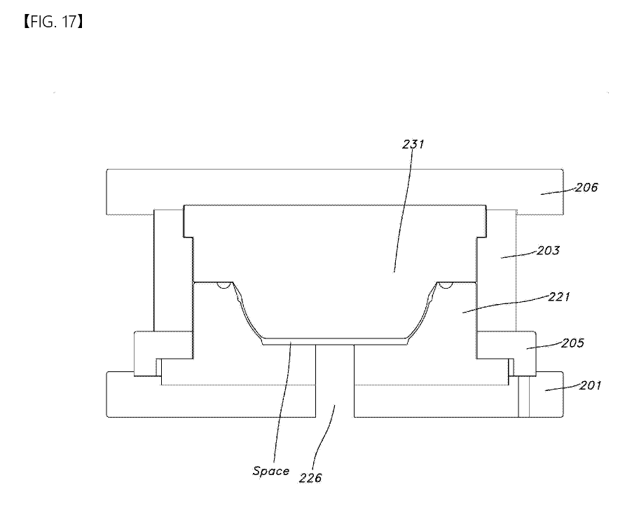

As shown in FIG. 17, the cavity (space) is formed between the body mold 221 and the plunger 231 when the plunger 231 is guided by the ring mold 203 and inserted into the recess 221c of the body mold 221. The main body of the cooking container is formed of molten aluminum contained in the cavity (space).

In order to mold the main body of the cooking container, firstly, the press member 206 and the plunger 231 are lifted and a molten aluminum alloy is injected into the recess 221c of the body mold 221. In addition, as shown in FIG. 18, the press member 206 is pressed in a state in which the molten aluminum alloy is injected into the recess 221c of the body mold 221, so that the plunger 231 presses the molten aluminum alloy contained in the recess 221c of the body mold 221 as the plunger 231 is inserted into the recess 221c of the body mold 221.

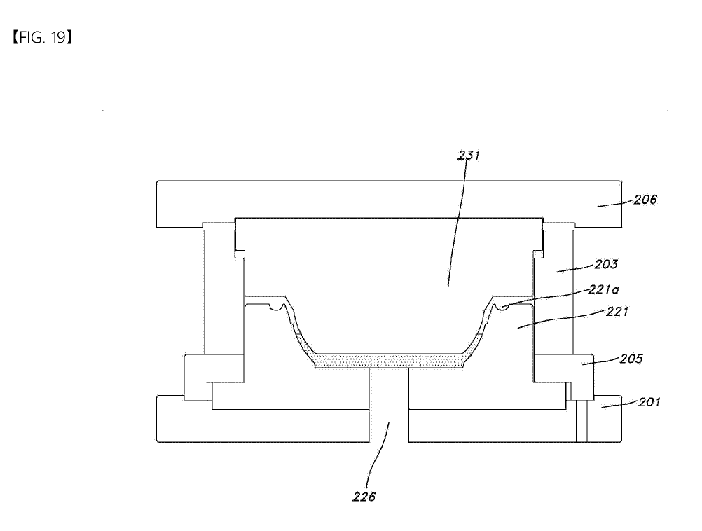

As shown in FIG. 19, the molten aluminum alloy contained in the recess 221c of the body mold 221 is pressed as the plunger 231 is lowered, and when the plunger 231 is lowered to press the molten aluminum alloy, the molten aluminum alloy contained in the recess 221c of the body mold 221 gradually rises to fill the cavity (space) between the body mold 221 and the plunger 231. Such a process is performed until the molten aluminum alloy contained in the recess 221c of the body mold 221 rises to fill the cavity (space) between the body mold 221 and the plunger 231 and a rim of the container is formed.

As show in in FIG. 19, the molten aluminum alloy contained in the recess 221c of the body mold 221 is pressed as the plunger 231 is lowered, so that the molten aluminum alloy contained in the recess 221c of the body mold 221 rises to form the rim of the container, and a remaining molten aluminum alloy is filled in an extra groove 221a so as to be prevented from flowing out of the mold device 200 for the liquid metal forging.

When a molding process of the main body of the cooking container is completed as the molten aluminum alloy is cooled and hardened, the press member 231 and the plunger 231 are lifted, and the main body of the cooking container is lifted by a pick-up pin 207.

AC4C, which is an Al—Si—Mg-based alloy, or AC8C, which is an Al—Si—Cu—Mg—Ni-based alloy, according to Japanese Industrial Standard (JIS) is used as the aluminum alloy for molding the cooking container main body.

AC4C, which is the Al—Si—Mg-based alloy, includes: 0.25% or less of Cu; 6.5% to 7.5% of Si; 0.20% to 0.45% of Mg; 0.35% or less of Zn; 0.55% or less of Fe; 0.35% or less of Mn; 0.10% or less of Ni; 0.20% or less of Ti; 0.10% or less of Pb; 0.05% or less of Sn; 0.10% or less of Cr; and a remainder being Al.

In addition, AC8C, which is the Al—Si—Cu—Mg—Ni-based alloy, includes: 2.0% to 4.0% of Cu; 8.5% to 10.5% of Si; 0.50% to 1.5% of Mg; 0.50% or less of Zn; 1.0% or less of Fe; 0.50% or less of Mn; 0250% or less of Ni; 0.20% or less of Ti; 0.10% or less of Pb; 0.10% or less of Sn; 0.10% or less or Cr; and a remainder being Al.

FIG. 21 shows the main body of the cooking container which is separated from the mold device 120 for the liquid metal forging. In the main body of the cooking container which is separated from the mold device 120 for the liquid metal forging, as shown in FIG. 21, an extra part 14 formed by the molten aluminum alloy filled in the extra groove is attached to a rim 12 of the container, and the extra part 14 is cut away to form the cooking container main body in a state where the magnetic metal plate can be attached to the cooking container main body.

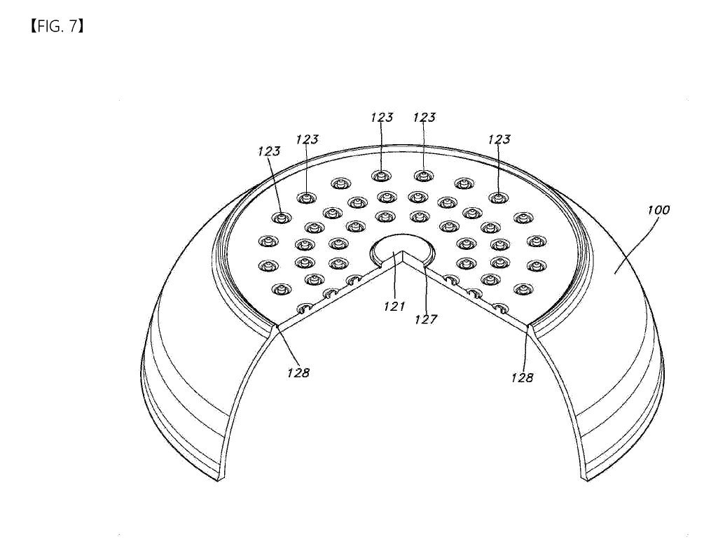

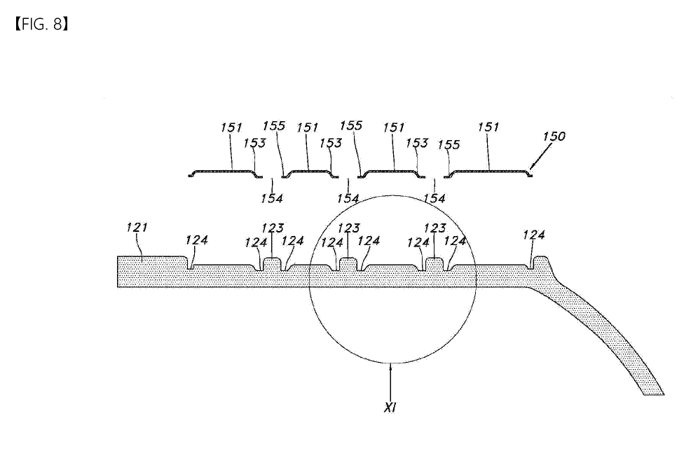

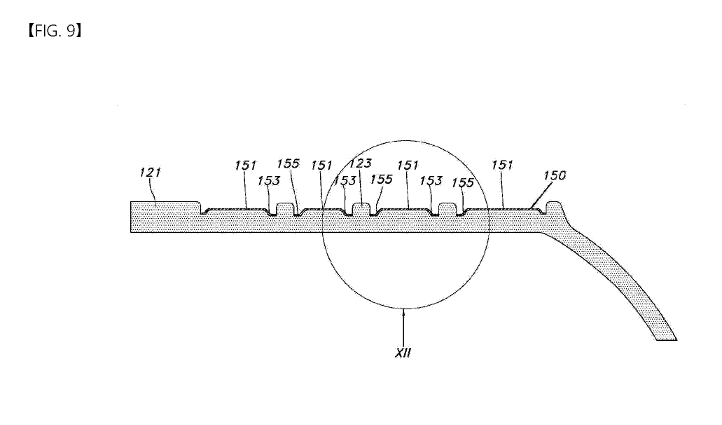

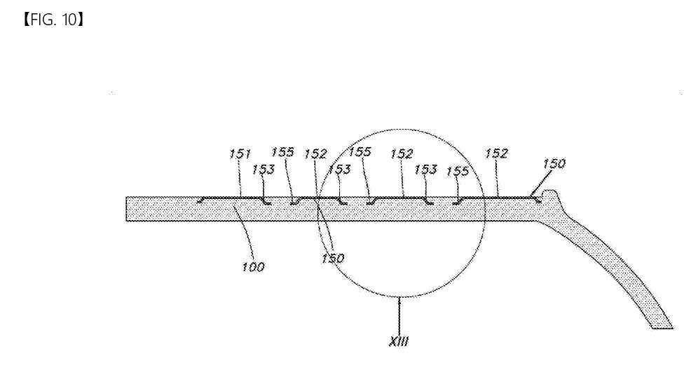

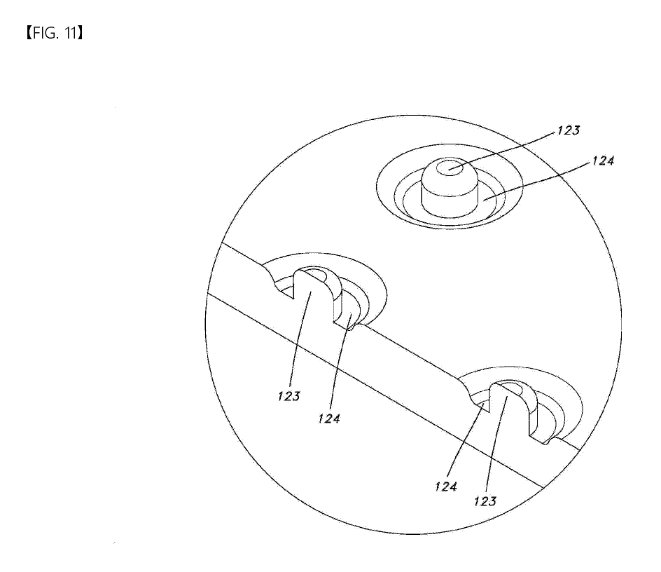

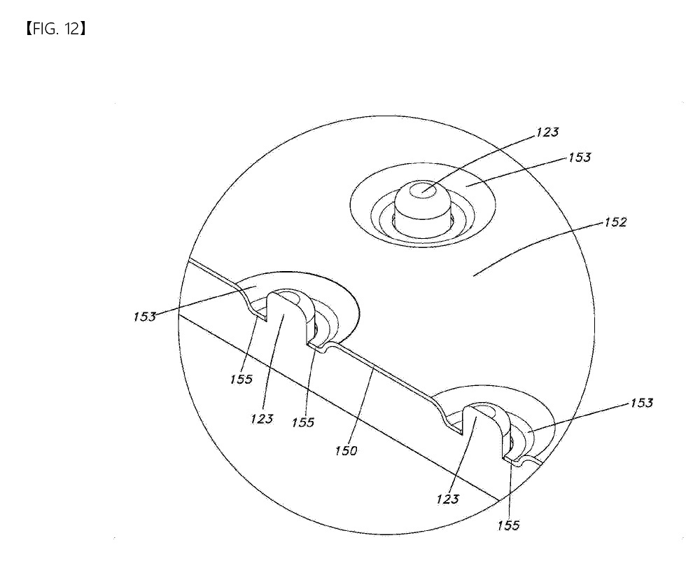

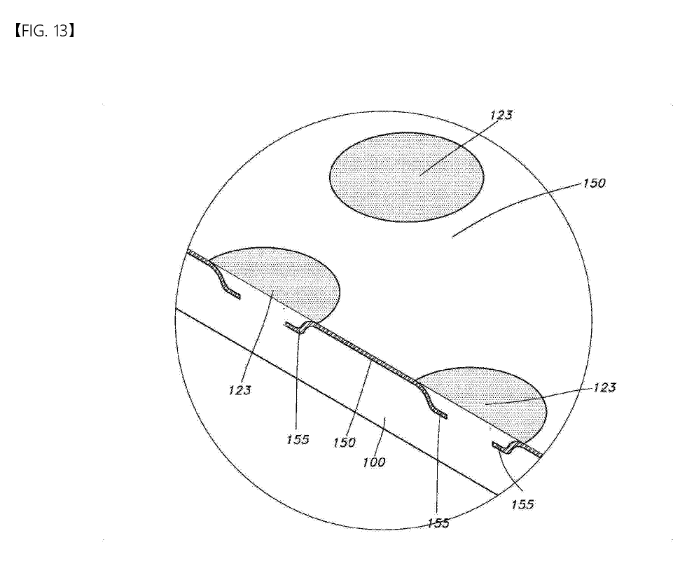

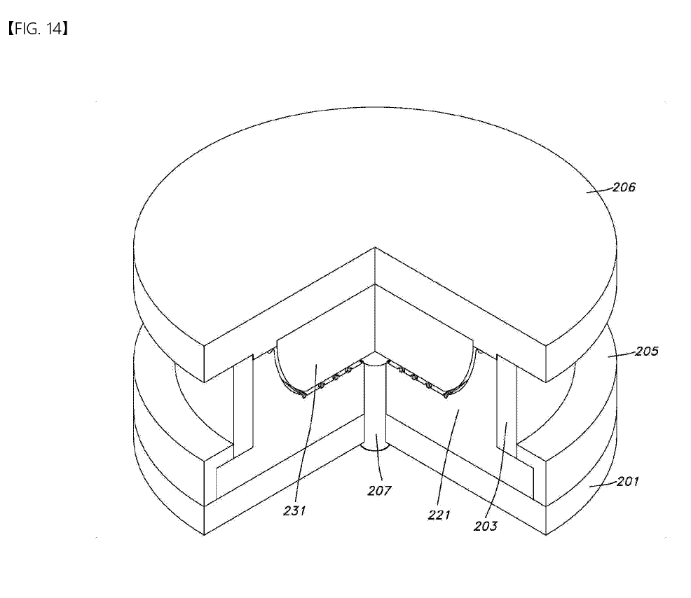

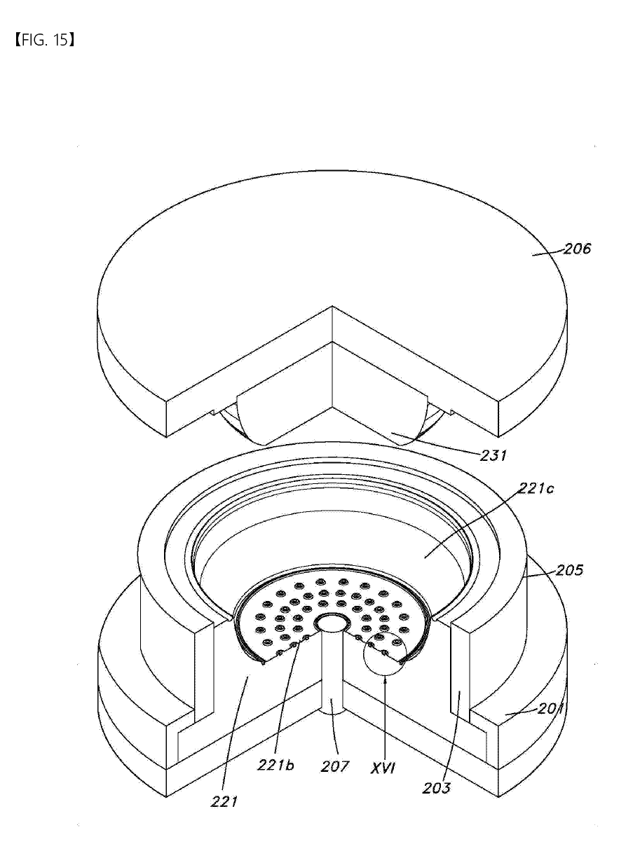

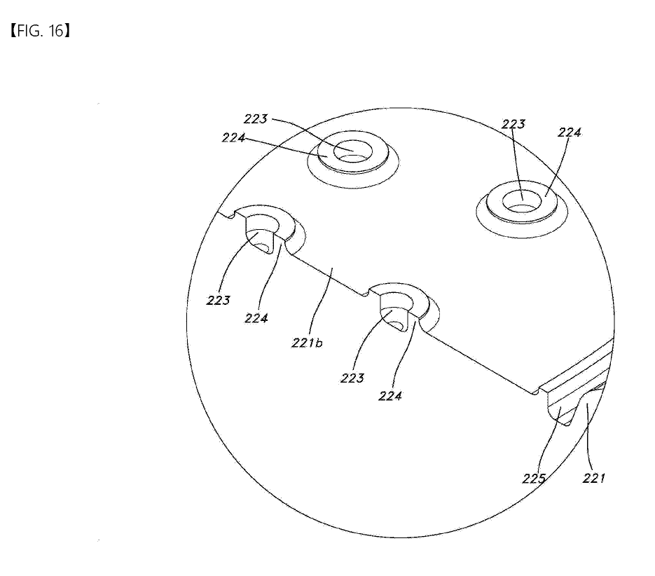

In this case, the molten aluminum alloy is injected into the recess 221c of the body mold 221 in which a boss 123 and a groove 124 for attaching the magnetic metal plate to the main body of the cooking container for the electromagnetic induction heating are formed, so that it is easy to prepare a semi-finished product of the cooking container main body as shown in FIG. 7, which has shapes reverse to shapes of the boss 123 and the groove 124 on the bottom surface of the main body of the cooking container for the electromagnetic induction heating. In other words, the boss 123 and the groove 124 formed on the bottom surface of the cooking container main body may have shapes reverse to shapes of the recess 223 and a groove 224 formed on the bottom surface of the body mold, respectively.

According to the present invention, since the semi-finished product of the cooking container main body is formed of the aluminum alloy in a liquid state by the mold device 200 for the liquid metal forging, the manufacture is facilitated even when the bottom surface has a complicated shape.

According to the present invention, the side surface of the bowl-shape groove of the magnetic metal plate is buried in the cooking container main body, so that the magnetic metal plate can be prevented from being separated from the container main body. In addition, since the side surface of the bowl-shape groove of the magnetic metal plate is buried in the cooking container main body, it is possible to remarkably reduce foreign substances being caught in a gap formed between the container main body and the magnetic metal plate, and the present invention has industrial applicability in that heat transfer efficiency is remarkably increased between the container main body and the magnetic metal plate.

What is claimed is:

1. A cooking container for an electromagnetic induction heating, the cooking container comprising:
a cooking container main body formed of an aluminum alloy; and
a magnetic metal plate attached to an outer bottom surface of the cooking container main body,
wherein the magnetic metal plate is formed at a surface thereof with a plurality of grooves having a bowl shape formed by pressing the surface of the magnetic metal plate, in which the bowl-shape groove is formed at a bottom thereof with a boss through-hole, and
the cooking container main body has a plurality of bosses passing through boss through-holes of the grooves of the magnetic metal plate, in which the bosses are pressed to fill the bowl-shape grooves, respectively, such that a side surface of the bowl-shape groove of the magnetic metal plate is buried in the cooking container main body.

2. The cooking container of claim 1, wherein an aluminum alloy portion of a bottom surface of the cooking container is exposed out of the magnetic metal plate.

3. The cooking container of claim 2, wherein the magnetic metal plate and the aluminum alloy portion exposed out of the magnetic metal plate are coplanar with each other.

4. The cooking container of claim 3, wherein a flange is formed around the boss through-hole.
